(19) United States
(12) Patent Application Publication
(10) Pub. No.: US 2016/0106084 A1
(43) Pub. Date: Apr. 21, 2016

(54) Ice Depresser Device

(71) Applicant: Danny Lee Shupe, Williston, ND (US)

(72) Inventor: Danny Lee Shupe, Williston, ND (US)

(21) Appl. No.: 14/516,775

(22) Filed: Oct. 17, 2014

(51) Int. Cl. A01K 97/01; B01D 29/05

(52) U.S. Cl. CPC A01K 97/01; B01D 29/05

(57) ABSTRACT

An ice depresser device for both clearing ice shavings from an ice hole and pumping dirty water from below such an ice hole. The ice depresser device generally includes a filter disc and a handle extending from the filter disc. The filter disc includes an upper cavity defined by a first flange and a lower cavity defined by a second flange. A plurality of filter openings are included across the body of the filter disc. As the filter disc is pushed downwardly through an ice hole, ice shavings will be pushed downwardly by the lower cavity to be swept away by the undercurrent. Other ice shavings will be pushed upwardly to be retained within the upper cavity by the pump action of the filter disc as it is drawn out of the ice hole. Thus, ice shavings or other debris may be both pushed under the current and removed from the ice hole utilizing the present invention.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to an ice hole aid and more specifically it relates to an ice depresser device for both clearing ice shavings from an ice hole and pumping dirty water from below such an ice hole.

2. Description of the Related Art

Any discussion of the related art throughout the specification should in no way be considered as an admission that such related art is widely known or forms part of common general knowledge in the field.

Ice fishing has exploded in popularity throughout the world. When ice fishing, an ice hole is generally drilled down through the ice to reach the underlying body of water such as a lake or river. However, the act of drilling the hole will fill the ice hole and surrounding area with ice shavings which impede fishing when allowed to fill the ice hole. Further, the ice shavings may encourage and aid the ice hole in prematurely freezing over.

While ice scoops are commonly used for removing such ice shavings, they have been shown to be inefficient by requiring multiple scoops and repeated attempts. Further, they rarely aid in removing all of the ice shavings from an ice hole. Finally, these ice scoops do not aid in removing dirty water from the surface of the ice hole.

Because of the inherent problems with the related art, there is a need for a new and improved ice depresser device for both clearing ice shavings from an ice hole and pumping dirty water from below such an ice hole.

### BRIEF SUMMARY OF THE INVENTION

The invention generally relates to an ice depresser aid which includes a filter disc and a handle extending from the filter disc. The filter disc includes an upper cavity defined by a first flange and a lower cavity defined by a second flange. A plurality of filter openings are included across the body of the filter disc. As the filter disc is pushed downwardly through an ice hole, ice shavings will be pushed downwardly by the lower cavity to be swept away by the undercurrent. Other ice shavings will be pushed upwardly to be retained within the upper cavity by the pump action of the filter disc as it is drawn out of the ice hole. Thus, ice shavings or other debris may be both pushed under the current and removed from the ice hole utilizing the present invention.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention.

FIG. 2 is an upper perspective exploded view of the present invention.

FIG. 3 is a lower perspective view of the present invention.

FIG. 4 is a frontal view of the present invention.

FIG. 5 is a top view of the present invention.

FIG. 6 is a bottom view of the present invention without the handle.

FIG. 7 is a top view of the present invention with the handle.

FIG. 8 is a cross-sectional view taken along line 8-8 of FIG. 5.

FIG. 9 is a side cutaway view of the present invention aligned for lowering into an ice hole.

FIG. 10 is a side cutaway view of the present invention being lowered into an ice hole.

FIG. 11 is a side cutaway view of the present invention being removed from an ice hole with ice shavings.

FIG. 12 is an upper perspective view of an alternate embodiment of the present invention with serrated edges, an impeller, and an adjustable handle.

FIG. 13 is a lower perspective view of the alternate embodiment of the present invention.

FIG. 14 is a frontal view of the alternate embodiment of the present invention.

### DETAILED DESCRIPTION OF THE INVENTION

### A. Overview

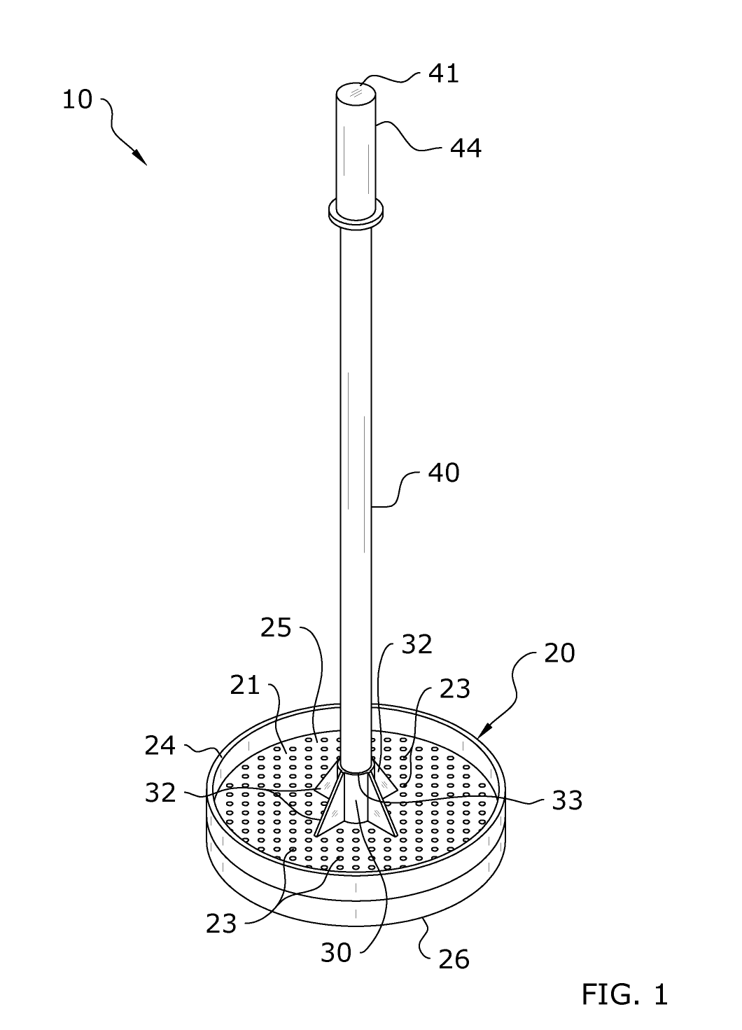

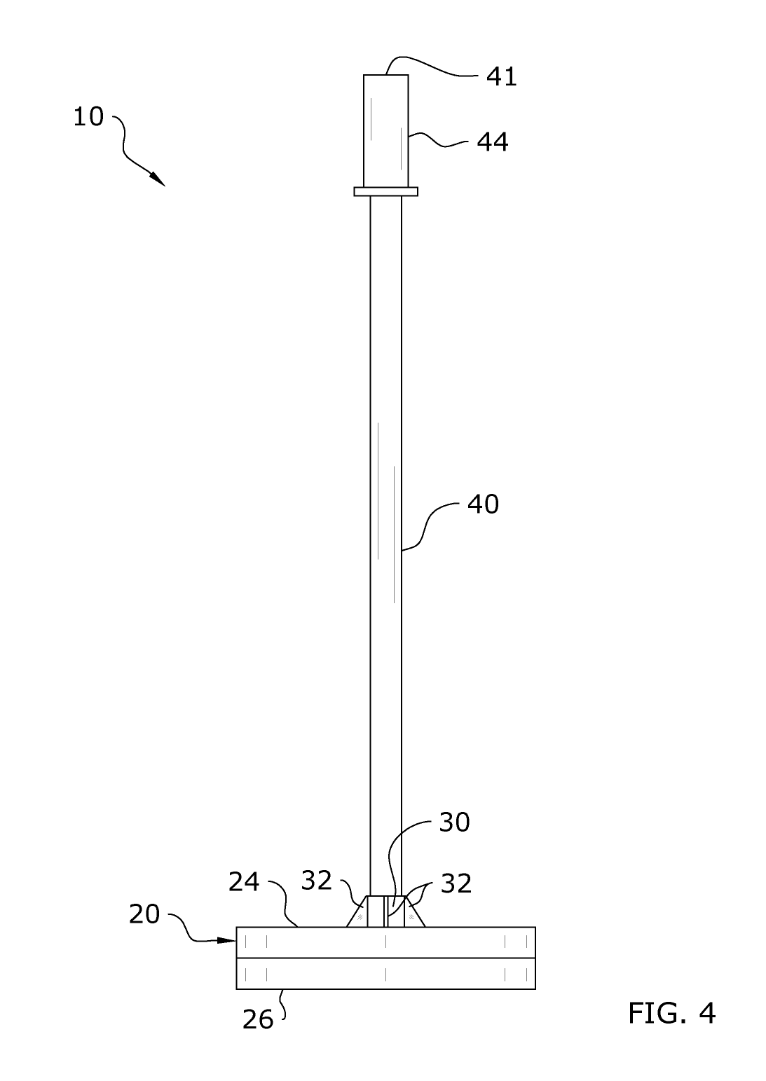

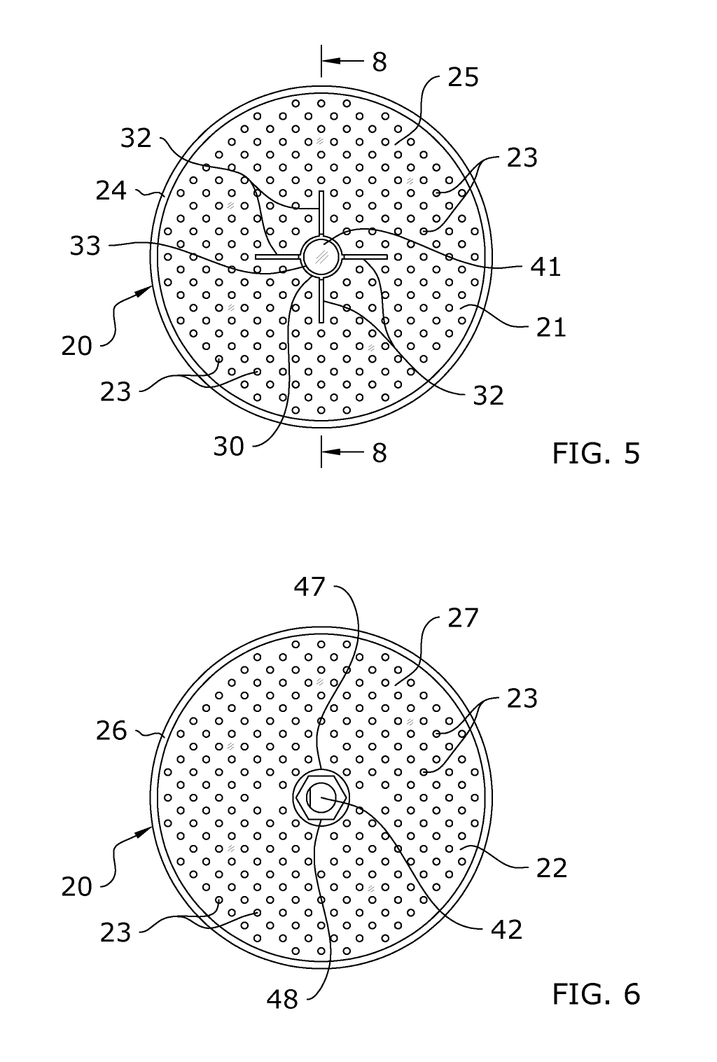

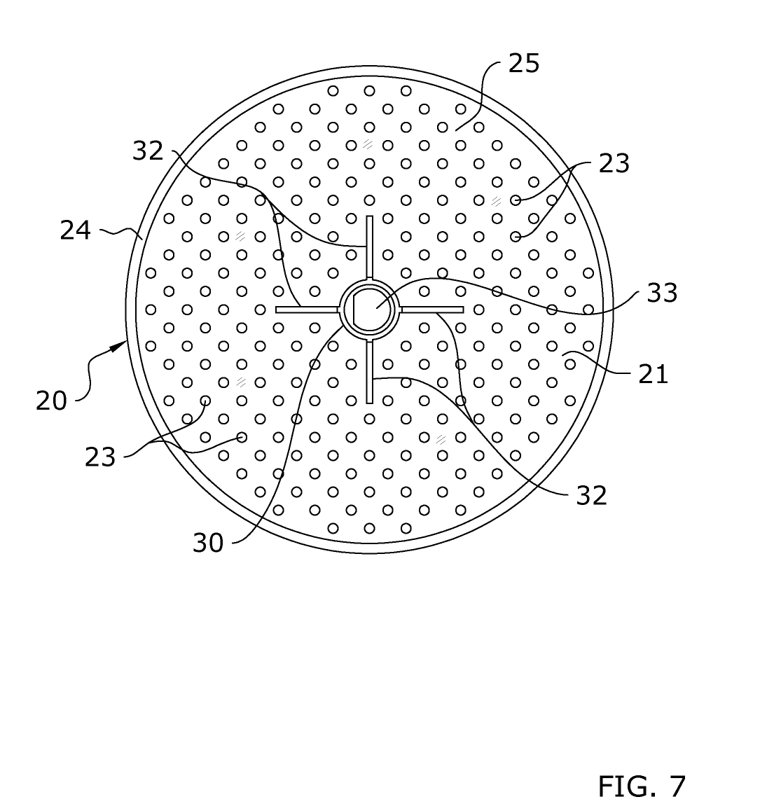

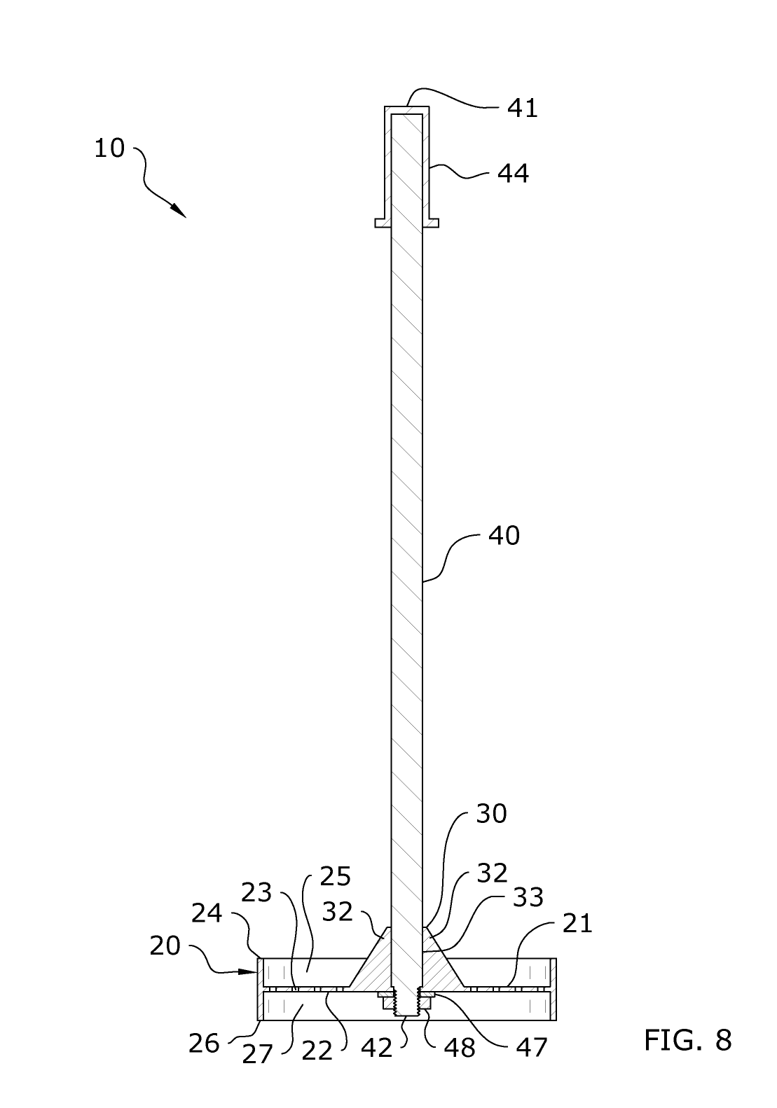

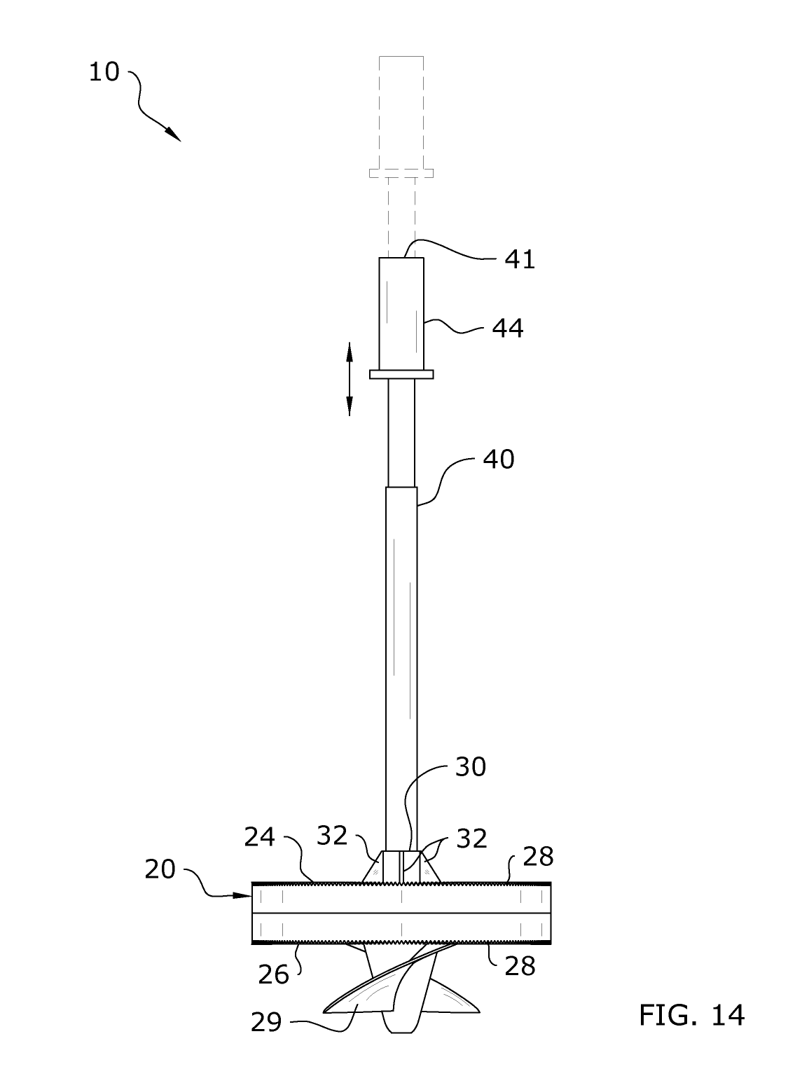

Turning now descriptively to the drawings, in which similar reference characters denote similar elements throughout the several views, FIGS. 1 through 14 illustrate an ice depresser device 10, which comprises a filter disc 20 and a handle 40 extending from the filter disc 20. The filter disc 20 includes an upper cavity 25 defined by a first flange 24 and a lower cavity 27 defined by a second flange 26. A plurality of filter openings 23 are included across the body of the filter disc 20. As the filter disc 20 is pushed downwardly through an ice hole 12, ice shavings 13 will be pushed downwardly by the lower cavity 27 to be swept away by the undercurrent. Other ice shavings 13 will be pushed upwardly to be retained within the upper cavity 25 by the pump action of the filter disc 20 as it is drawn out of the ice hole 12. Thus, ice shavings 13 or other debris may be both pushed under the current and removed from the ice hole 12 utilizing the present invention.

### B. Filter Disc

As shown throughout the figures, the present invention includes a filter disc 20 which is lowered through an ice hole 12 to collect ice shavings 13 and then removed from the ice hole 12 to remove the ice shavings 13. The shape, structure, and configuration of the filter disc 20 may vary in different embodiments.

The exemplary figures illustrate a circular filter disc 20 which is suitable for most ice holes 12. However, other shapes, such as rectangular, triangular, and the like, may be utilized for the filter disc 20 for different applications. Further, the filter disc 20 will comprise different sizes for different applications. Thus, the shape, size, structure, and configuration of the filter disc 20 should not be construed as limited by the exemplary figures.

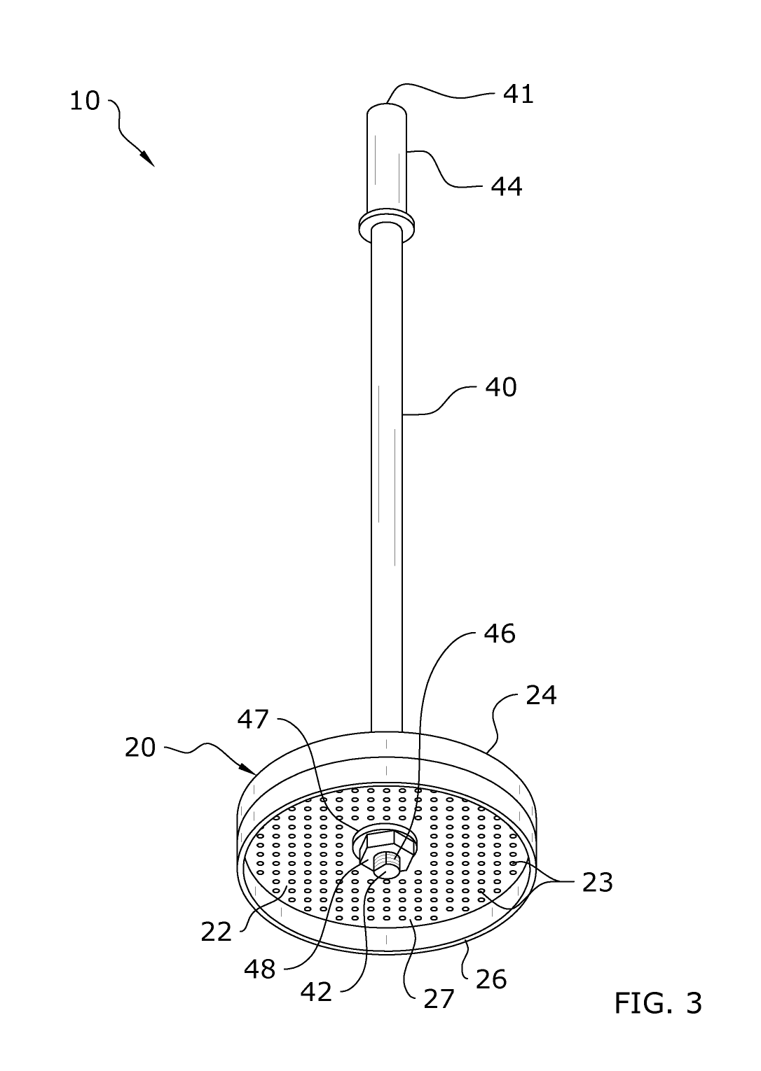

As best shown in FIGS. 1-3, the filter disc 20 preferably comprises a circular disc-shape having an upper surface 21 and a lower surface 22. The handle 40 of the present invention will extend upwardly from the upper surface 21 of the filter disc 20 when the present invention is fully assembled as shown in FIG. 1. A nut 48 secures the lower end 42 of the handle 20 against the lower surface 22 of the disc as shown in FIG. 3.

The filter disc 20 includes a plurality of openings 23 as shown throughout the figures. The spacing, size, shape, numbering, and configuration of the openings 23 may vary for different embodiments to suit different applications. In a preferred embodiment, a grid of openings 23 substantially covers the entirety of the filter disc 20. Each of the openings 23 extends fully between the upper and lower surfaces 21, 22 of the filter disc 20.

The openings 23 act to filter water as the filter disc 20 is pulled out from the ice hole 12. The openings 23 will allow water to freely fall therethrough while retaining ice shavings 13 or any other debris against the upper surface 21 of the filter disc 20 so as to be removed from the ice hole 12. The shape and size of the openings 23 may vary for filtering of differently-sized debris or ice shavings 13.

As best shown in FIG. 1, a first flange 24 extends upwardly from the outer circumference of the filter disc 20. The first flange 24 fully surrounds the upper surface 21 of the filter disc 20 to define an upper cavity 25 on the upper surface 21 of the filter disc 20 as shown throughout the figures. This upper cavity 25 will act to retain ice shavings 13 and other debris against the upper surface 21 of the filter disc 20 when it is removed from the ice hole 12. The size, shape, and configuration of the first flange 24 may vary in different embodiments of the present invention.

As best shown in FIG. 3, a second flange 26 extends downwardly from the outer circumference of the filter disc 20. The second flange 26 fully surrounds the lower surface 22 of the filter disc 20 to define a lower cavity 27 on the lower surface 22 of the filter disc 20 as shown throughout the figures. This lower cavity 27 will aid in pushing ice shavings 13 and other debris down under the ice hole 12 to be swept away in the undercurrents of the body of water.

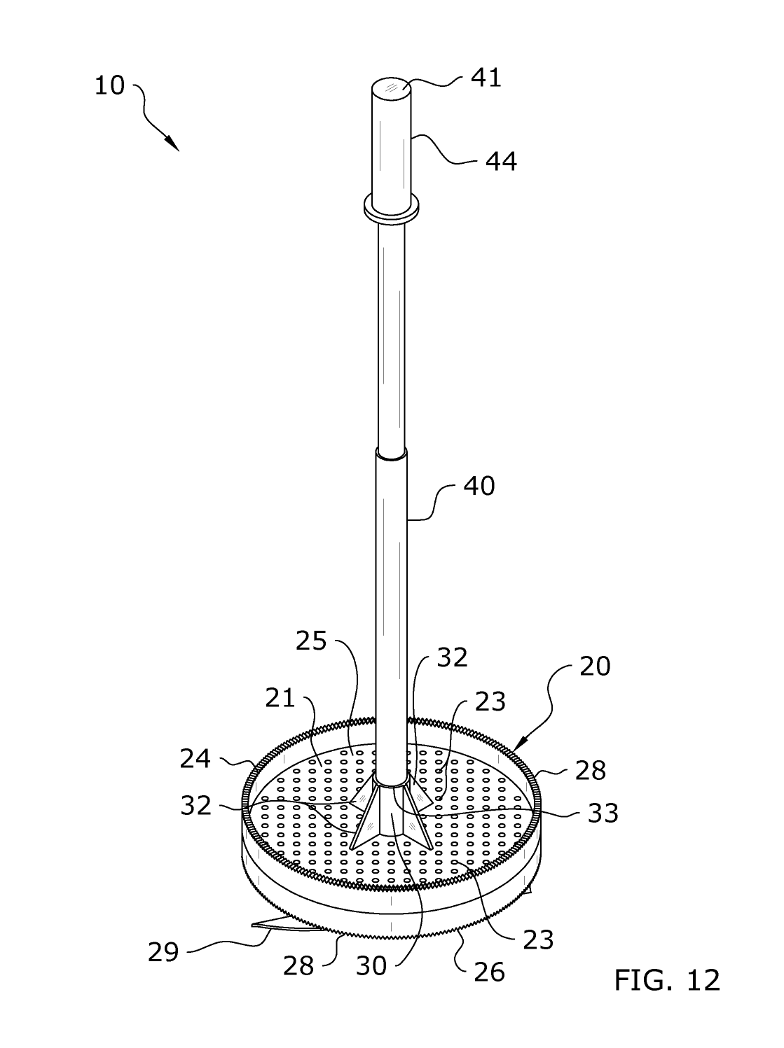

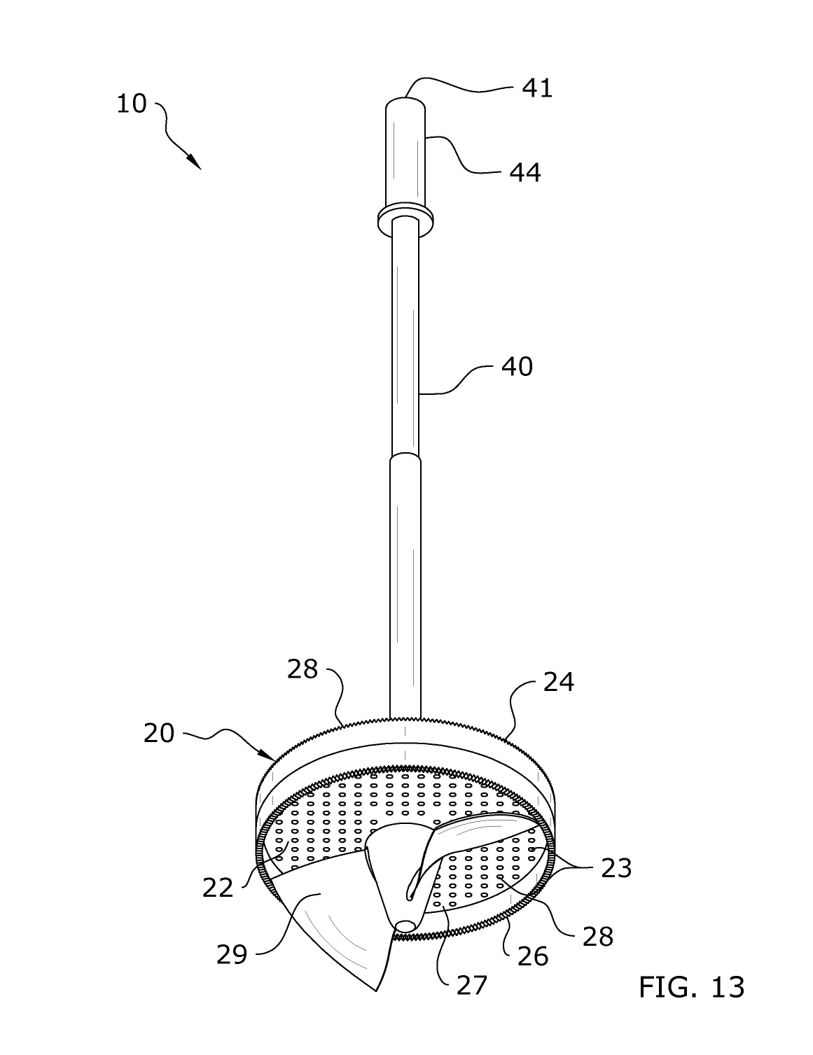

As shown in FIGS. 12-14, the first flange 24, the second flange 26, or both flanges 24, 26 may include a serrated edge 27. The serrated edge 27 aids with clearing ice from in and around the ice hole 12, particularly around its edges. The shape, size, numbering, and configuration of the serrated edge 27 may vary, with the jaws being larger in some embodiments and smaller in others.

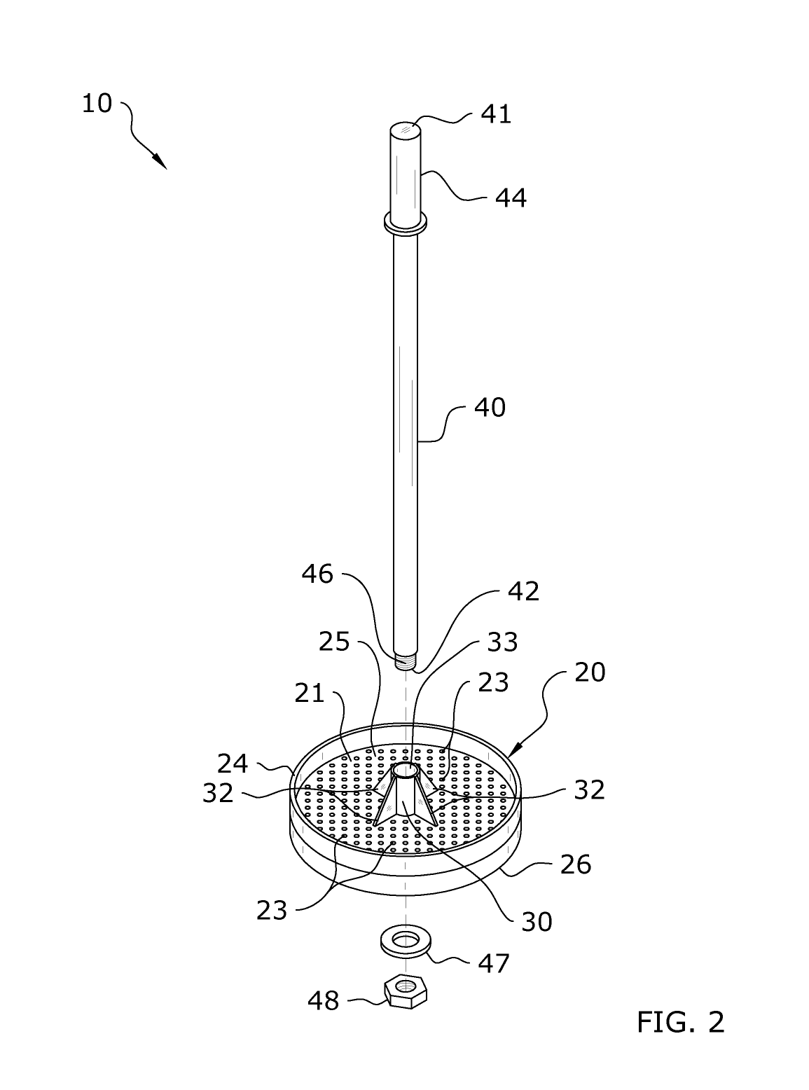

As best shown in FIG. 2, the filter disc 20 may include a receiver 30 for removably securing a handle 40 to the filter disc 20. The receiver 30 will generally extend upwardly from a central location on the upper surface 21 of the filter disc 20 as shown throughout the figures. The shape, size, and configuration of the receiver 30 may vary in different embodiments. Further, a discrete receiver 30 may be omitted in some embodiments, with the handle 40 being connected to the filter disc 20 through other means, such as through integrally forming the handle 40 and filter disc 20.

In a preferred embodiment as shown in the figures, the receiver 30 comprises a tubular member which extends from the central portion of the filter disc 20. The tubular receiver 30 comprises a tubular shaft or cylinder which includes a receiver opening 33 adapted to allow the handle 40 to pass therethrough.

In some embodiments, such as shown in FIG. 1, one or more reinforcement ribs 32 may extend from the outer circumference of the receiver 30. In a preferred embodiment, each of the reinforcement ribs 32 will be comprised of a triangular configuration. The reinforcement ribs 32 will preferably surround the receiver 30 so as to reinforce the strength and durability of the invention overall. In some embodiments, a separate receiver 30 may be omitted, with the receiver opening 33 being defined by a plurality of interconnected reinforcement ribs 32.

As shown in FIGS. 12-14, the present invention may in some embodiments include an impeller 29 extending downwardly from the filter disc 20. The impeller 29, which is preferably secured to the lower surface 22 of the filter disc 20, aids with creating a whirlwind effect to clear ice shavings 13 and the like from the ice hole 12. The shape, structure, size, and configuration of the impeller 29 may vary in different embodiments. The impeller 29 should not be construed as being limited by the S-shaped configuration shown in the figures. The impeller 29 could be fixedly or rotatably secured to the filter disc 20.

### C. Handle

The present invention includes a handle 40 as shown throughout the figures. The handle 40 is utilized to both push the filter disc 20 down through the ice hole 12 and to remove the filter disc 20 from the ice hole 12. While the figures illustrate a removably-secured handle 40, it should be appreciated that the present invention may utilize a fixedly-secured handle 40 in some embodiments. In such embodiments, the handle 40 may be integrally formed with the filter disc 20. The handle 40 may also be adjustable, such as through a telescopic configuration, as shown in FIGS. 12-14.

In the preferred embodiment shown in the figures, the handle 40 is removably secured to the filter disc 20 and comprises an elongated member having an upper end 41 and a lower end 42. The handle 40 may comprise various shapes, dimensions, and configurations, and should not be construed as limited by the figures. The length in particular may vary widely to suit different types of ice holes 12.

The upper end 41 of the handle 40 may include a grip 44 as shown throughout the figures. The grip 44 will aid in manipulation of the handle 40 by increasing grip on the handle 40 during use. The grip 44 may be comprised of various configurations, such as an ergonomic configuration. The grip 44 may be comprised of various materials, such as rubber or the like.

The lower end 42 of the handle 40 includes a threaded portion 46. The lower end 42 of the handle 40 is extended through the receiver opening 33 to extend out from under the lower surface 22 of the filter disc 20. A washer 47 and nut 48 are then secured to a threaded portion 46 on the lower end 42 of the handle 40 to secure the handle 40 to the filter disc 20, such as shown in FIG. 3.

### D. Operation of Preferred Embodiment

In use, the handle 40 is first secured to the filter disc 20 as shown in FIGS. 2 and 3. The lower end 42 of the handle 40 is inserted through the receiver opening 33 to extend out from the lower surface 22 of the filter disc 20. A washer 47 and nut 48 may be positioned around the lower end 42 of the handle 40. The nut 48 may be secured to the threaded portion 46 of the handle 40 to secure the handle 40 to the filter disc 20.

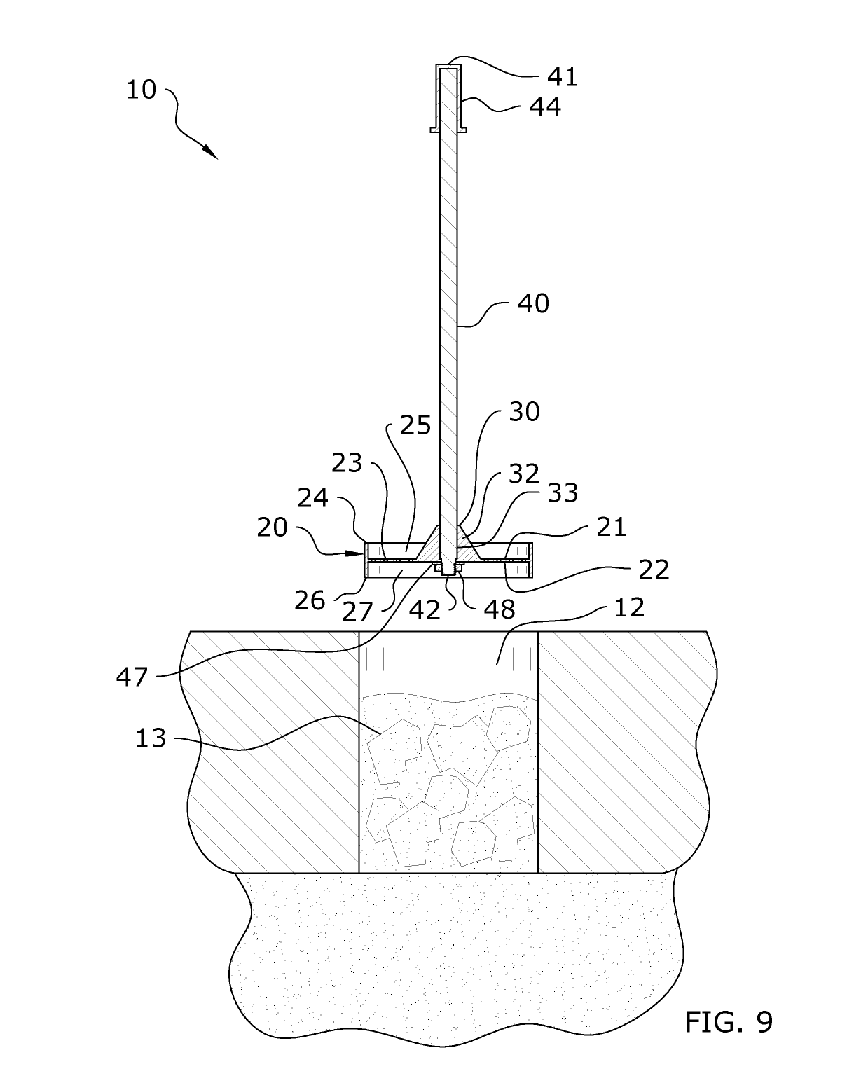

With the handle 40 secured to the filter disc 20 as shown in FIG. 9, the present invention is ready for use. After drilling an ice hole 12, the filter disc 20 is pushed down through the ice hole 12 using the handle 40. As the filter disc 20 travels downwardly through the ice hole 12, the lower cavity 27 will collect and push any ice shavings 13 or debris downwardly to ideally be caught by the undercurrent of the body of water.

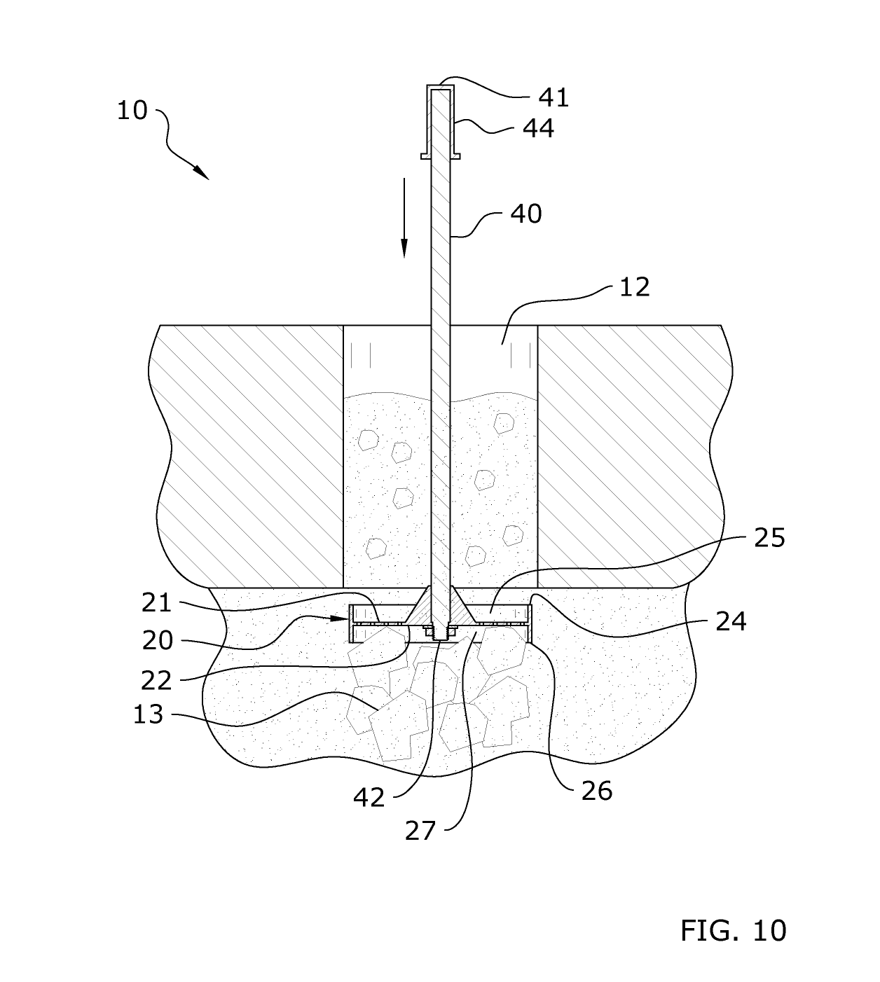

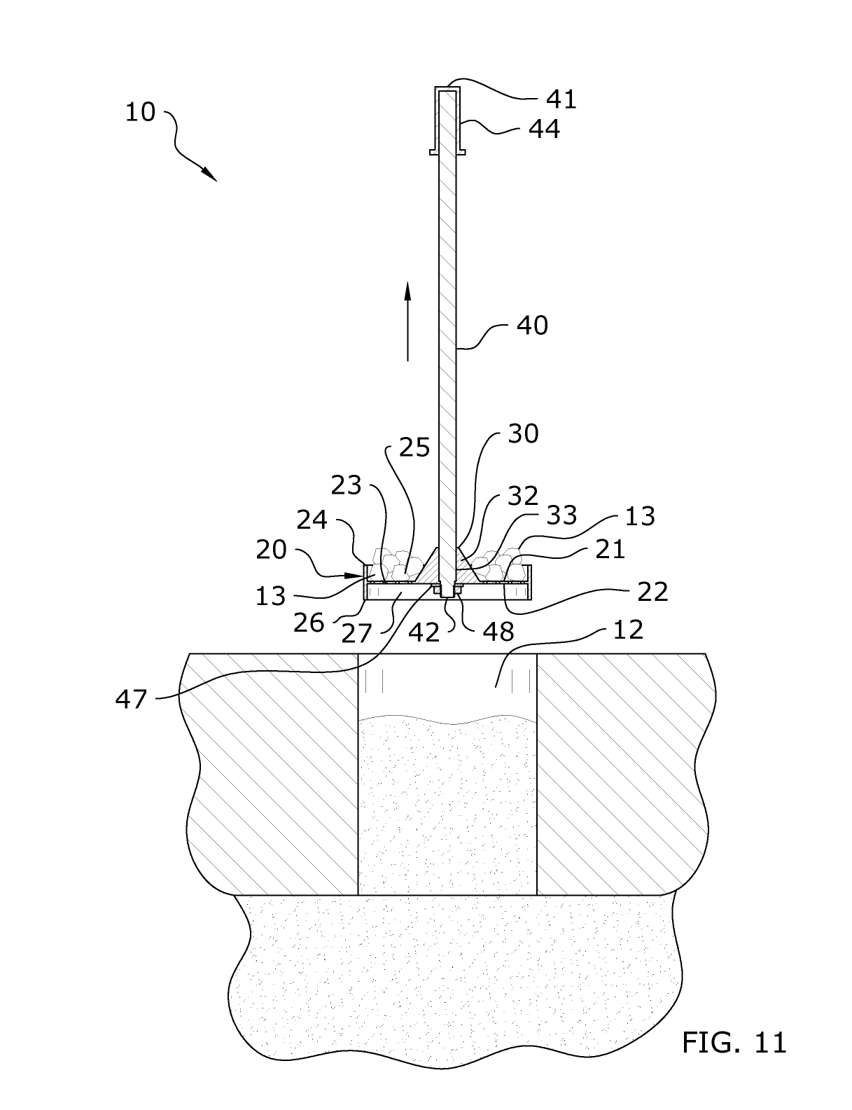

The downward stroke of the filter disc 20 shown in FIG. 10 will also cause a piston-pumping effect, pumping water and ice shavings 13 up around the first flange 24 to be retained within the upper cavity 25. As the filter disc 20 is pulled out from the water on an upward stroke as shown in FIG. 11, ice shavings 13 and debris will be retained within the upper cavity 25 while water will pass through the openings 23 and back into the ice hole 12. The ice shavings 13 and debris may then be removed from the upper cavity 25. These steps may be repeated until the ice hole 12 is completely clear of ice shavings 13 or debris. If the ice hole 12 begins to freeze over during fishing, the steps may be repeated to further clear the ice hole 12.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described above. All publications, patent applications, patents, and other references mentioned herein are incorporated by reference in their entirety to the extent allowed by applicable law and regulations. The present invention may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

The invention claimed is:

1. An ice depresser device, comprising:
a filter disc comprising an upper surface and a lower surface, said filter disc including a plurality of openings;
a first flange surrounding said upper surface of said filter disc to define an upper cavity;
a second flange surrounding said lower surface of said filter disc to define a lower cavity; and
a handle extending from said filter disc.

2. The ice depresser device of claim 1, wherein said filter disc includes a receiver for removably securing said handle to said filter disc.

3. The ice depresser device of claim 2, wherein said receiver includes a receiver opening for receiving said handle.

4. The ice depresser device of claim 3, wherein said receiver includes a plurality of reinforcement ribs.

5. The ice depresser device of claim 4, wherein said receiver opening is defined by said plurality of reinforcement ribs.

6. The ice depresser device of claim 1, wherein said handle includes a grip at its under end.

7. The ice depresser device of claim 1, wherein a lower end of said handle includes a threaded portion.

8. The ice depresser device of claim 7, further comprising a nut for securing to said threaded portion of said handle.

9. The ice depresser device of claim 8, further comprising a washer for use with said nut.

10. The ice depresser device of claim 1, wherein said plurality of openings are comprised of a grid of openings covering a body of said filter disc.
